(19) United States
(12) Patent Application Publication
(10) Pub. No.: US 2025/0251523 A1
(43) Pub. Date: Aug. 7, 2025

(54) GEOLOGY, TEMPERATURE, GEOPHYSICS, STRESS ORIENTATIONS, AND NATURAL FRACTURING

(71) Applicant: Fervo Energy Company, Houston, TX (US)

(72) Inventors: Steven Fercho, Reno, NV (US); Gabe Matson, Houston, TX (US); Emma G. McConville, Reno, NV (US); Greg Rhodes, Houston, TX (US); Ryan Jordan, Houston, TX (US); Jack Norbeck, Golden, CO (US)

(21) Appl. No.: 19/047,416

(22) Filed: Feb. 6, 2025

Related U.S. Application Data
(60) Provisional application No. 63/550,307, filed on Feb. 6, 2024.

(51) Int. Cl. G01V 3/38; G01V 3/08; G01V 3/34; G01V 7/06; G01V 9/00; G01V 11/00

(52) U.S. Cl. CPC G01V 3/38; G01V 3/083; G01V 3/34; G01V 7/06; G01V 9/005; G01V 11/002

(57) ABSTRACT

The present invention relates to systems and methods for developing and characterizing geothermal well systems. Data collected from a survey area is used to generate a 3D geologic model and a temperature distribution model of a subsurface region in the survey area. Using the 3D geologic model and the temperature distribution model, a vertical observation well is drilled to a specified depth, facilitating further collection of data from the survey area and improvement of the 3D geologic model and the temperature distribution model.

### CLAIM OF PRIORITY

This application claims the benefit of U.S. Provisional Patent Application Ser. No. 63/550,307, filed on Feb. 6, 2024, titled “GEOLOGY, TEMPERATURE, GEOPHYSICS, STRESS ORIENTATIONS, AND NATURAL FRACTURING IN THE MILFORD VALLEY, UT INFORMED BY THE DRILLING RESULTS OF THE FIRST HORIZONTAL WELLS AT THE CAPE MODERN GEOTHERMAL PROJECT,” the contents of which is incorporated by reference herein in its entirety.

### FIELD OF THE INVENTION

The present invention relates to geologic modeling for applications in industries such as oil and gas, mining, and geothermal energy.

### BACKGROUND

Geologic modeling has widespread application in geothermal technologies. For example, geologic modeling is useful for analyzing complex geological structures, assessing geothermal resource potential, and identifying locations for development. Through the analysis of complex geologic structures, assessment of geothermal resource potential, and identification of locations for development, geologic modeling ultimately reduces exploration costs and production costs. However, geologic modeling faces various technical challenges with respect to, for example, inaccurate modeling of complex geological structures and uncertainty in subsurface models in early exploration stages. These technical challenges in geologic modeling lead to technical challenges in geothermal technologies with respect to exploration and development.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. It should be understood that additional and alternative examples are possible without departing from the principles of the subject matter described herein.

FIG. 1 illustrates an example of a natural resource system, in accordance with examples described herein.

FIG. 2 illustrates an example of a geothermal well system, in accordance with examples described herein.

FIG. 3 illustrates an example of magnetotelluric (MT) data of a geothermal well system, in accordance with examples described herein.

FIG. 4 illustrates an example of geologic data and temperature data of a geothermal well system, in accordance with examples described herein.

FIG. 5 illustrates an example of geologic data and temperature data of a geothermal well system, in accordance with examples described herein.

FIG. 6 illustrates an example of gravity data of a geothermal well system, in accordance with examples described herein.

FIG. 7 illustrates an example of gravity data of a geothermal well system, in accordance with examples described herein.

FIG. 8 illustrates an example of density data of a geothermal well system, in accordance with examples described herein.

FIG. 9 illustrates an example technique for developing and characterizing a geothermal well system, in accordance with examples described herein.

FIG. 10 illustrates an example of a machine upon which any one or more of the techniques discussed herein may perform, in accordance with examples described herein.

### DETAILED DESCRIPTION

Despite recent advances and widespread application in geothermal developments, geologic monitoring faces various technical challenges and limitations. For example, inaccessibility of the subsurface limits the data available to accurately map the subsurface geology and temperature distributions of an unexplored area. This limitation in available data leads to uncertainty in geologic models that hinders the efficient development of the area. These technical challenges are exacerbated in geothermal developments by the dynamic nature of geothermal systems as a poorly located well in a geothermal system may affect the productivity of future wells as well as the geothermal system as a whole. Thus, geologic monitoring in geothermal developments faces various technical challenges and limitations with respect to accurate modeling.

The systems and techniques described herein seek to address these and other technical challenges and limitations arising in the field of geothermal technologies. For example, techniques for developing and characterizing a geothermal well system include generating a three-dimensional (3D) geologic model of a subsurface region by conducting a gravity survey combined with density logs. The gravity survey includes gravity measurements from gravity measurement stations spaced apart by a threshold distance (e.g., 250 m to 1 km). The gravity measurement stations are spaced closer together in core survey areas (e.g., closer to a survey area center) and spaced farther apart in peripheral areas (e.g., farther from a survey area center). Generating the 3D geologic model includes collecting magnetotelluric (MT) data from MT stations. The MT stations are spaced apart by a threshold distance (e.g., 500 m to 3 km). The MT stations are spaced closer together in core survey areas and spaced farther apart in peripheral areas. Generating the 3D geologic model includes performing depth-limited one-dimensional (1D) inversions of the MT data. The depth-limited 1D inversions focus on specific frequency ranges that correspond to a depth of interest, such as by focusing on shallow resistivity patterns. Restricting the inversions to the depth of interest (e.g., predetermined depth range) facilitates focus on specific geological targets (e.g., smectite clay) and reduce the influence of deeper geological structures. Generating the 3D geologic model includes utilizing well data from existing wells in the survey area and re-interpreting lithologies from the well data based on the additional data obtained for the 3D geologic model. By using existing well data, the 3D geologic model builds on a reliable base model with improved accuracy and detail.

In some examples, a temperature distribution model of the subsurface region is generated using a radial basis function algorithm. The radial basis function algorithm incorporates temperature data from existing wells in the survey area and combines the measured well temperature data with statistically derived temperature gradients in areas that lack well data. Using a 3D interpolation of the measured well temperature data with the statistically derived temperature gradients, the radial basis function algorithm determines temperature distribution patterns that are used in the generation of the temperature distribution model.

In some examples, a vertical observation well is drilled to a specified depth based on the 3D geologic model and the temperature distribution model. A distributed temperature sensing (DTS) fiber system is installed in the vertical observation well. The DTS fiber system measures temperature profiles and provides temperature data for the vertical observation well. The temperature profiles and temperature data obtained through the DTS fiber system are used in conjunction with temperature data from wireline temperature logging equipment in horizontal wells to form complete temperature measurements across a geothermal system. For example, temperature sensors on a wireline cable are installed in horizontal wells in a geothermal system along with a DTS fiber system in a vertical observation well in the geothermal system. The temperature measurements from the wireline temperature sensors and the DTS fiber system are recorded over a predetermined period of time at various depths in the geothermal system. Integrating the measurements from the DTS fiber system and the wireline temperature sensors provides 3D temperature profiles of the geothermal system.

In some examples, horizontal wells are drilled based on the 3D geologic model and the temperature distribution model. For example, the horizontal wells are drilled in a wine rack pattern with wells stacked and staggered across different vertical depths (e.g., between 8,000 ft and 9,000 ft) and horizontal planes. The wine rack pattern targets multiple reservoirs in a single section. Each horizontal well in the section is laterally extended (e.g., at least 5,000 ft). The vertical staggering and the horizontal spacing of the horizontal wells are based on the 3D geologic model and the temperature distribution model.

In some examples, natural fractures in the subsurface region are characterized by collecting image logs from the horizontal wells, calculating fracture density along the horizontal wells, and measuring average fracture strike orientations along the horizontal wells. The image logs are integrated with sonic log data (e.g., from the DTS fiber system) to characterize the natural fractures in the subsurface region. For example, using image logs collected from the horizontal wells, fracture density is calculated at 50 ft intervals along the horizontal wells. Calculating the fracture density identifies areas of lower fracture density and areas of higher fracture density. The fracture densities calculated along the horizontal wells are correlated together to determine high fracture density zones. Using the image logs, average fracture strike orientations are measured at 500 ft intervals along the horizontal wells to determine the orientation of natural fractures in the subsurface region. The image log data is integrated with sonic log data to determine geomechanical properties (e.g., Young's Modulus, static Poisson's Ratio) of the subsurface region. For example, the measurement of compressional (e.g., P-wave) wave velocities and shear (e.g., S-wave) wave velocities from the sonic log data are correlated with the formation and fracture information determined from the image log data to identify zones where the geomechanical properties are consistent with the sonic log data and the image log data.

In some examples, clay zones in the subsurface region are mapped by correlating MT data inversions with well log data. For example, shallow, low resistivity clays are identified and targeted for depth-limited 1D inversions by resolving shallow resistivity patterns identified in the MT data. In a traverse electric (TE) mode, depth-limited 1D inversions are performed at MT sites where MT data is consistent with 1D assumptions indicated by low amplitude of on-diagonal MT impedance elements. The 1D MT resistivity models are reviewed in cross section and compared to well cutting analysis, resolving a thin and shallow low resistivity zone that correlates to clays identified in mud logs. By correlating MT data inversions, clay depth and thickness are predicted in the subsurface region.

In some examples, drilling induced fractures are measured to determine stress field orientation across a geothermal system. For example, using image log data and sonic data captured from the vertical observation well and the horizontal wells, characteristics of the drilling induced fractures, such as stress orientation and fracture length are determined. By analyzing the characteristics of the drilling induced fractures, the stress field orientation across the geothermal system is calculated. In some examples, the maximum horizontal compressive stress (e.g., SHmax) acting on the geothermal system is calculated based on the image log data and the sonic data captured with respect to the drilling induced fractures. The stress field orientation for the geothermal system can be used to inform the orientation of other systems within a survey area of the geothermal system.

In some examples, x-ray diffraction (XRD) analysis of well cuttings from pre-existing wells are used to identify and model volcanic packages in the subsurface region. The XRD analyses of the well cuttings inform the presence and extent of volcanics in deep portions of the subsurface region. For example, the well cuttings are exposed to X-rays using a diffractometer to identify diffraction patterns of the well cuttings. These diffraction patterns are compared with known mineral patterns to detect primary igneous minerals and secondary alteration minerals. Based on the relative abundance of these different minerals in the well cuttings, a composition of volcanic packages is determined. By analyzing well cuttings at different depths and locations within the subsurface region, the mineralogical variations of the subsurface region is modeled, informing the identification and modeling of volcanic packages of the subsurface region.

In some examples, the 3D geologic model is iteratively updated as wells are drilled and logged to progressively refine and improve the accuracy of the 3D geologic model. For example, existing well data related to a survey area serve as the base for building an initial model of the survey area. With the addition of, for example, gravity measurements and MT data, the initial model is updated with additional detail, improving the accuracy of the model. With the updated model, a vertical observation well is drilled. Based on the data gathered from the vertical observation well, the 3D geologic model is updated, providing additional information and accuracy to the model. With the updated model, horizontal wells can be drilled, and information gathered from the horizontal wells are used to update the model.

Systems for developing and characterizing a geothermal well system include a gravity survey module to collect gravity measurements from gravity measurement sites across a survey area. A MT data collection module collects MT data from MT stations across the survey area. A data processing module performs depth-limited 1D inversions of the MT data. The data processing module integrates the 1D inversions with gravity survey data from the gravity measurement sites, the MT data from the MT stations, and existing well log data to generate a 3D geologic model of the subsurface region of the survey area. The 3D geologic model identifies, for example, clay zones in the survey area based on the 1D inversions, the MT data, the gravity survey data, and the existing well data.

In some examples, the data processing module generates a temperature distribution model using a radial basis function algorithm. The temperature distribution model uses temperature profiles and temperature measurements obtained from a DTS fiber system installed in a vertical observation well and wireline temperature sensors installed in horizontal wells of the geothermal well system.

In some examples, an image logging module collects image logs from horizontal wells, calculates fracture density along the horizontal wells based on the image logs, and measures average fracture strike orientations based on the image logs. The systems integrate (e.g., using the data processing module) sonic log data with the image log data image logging module to identify natural fractures and orientations of these fractures. The stress field of the survey area is determined using this information. integrates sonic log data with the image log data to facilitate identifications of natural fractures and the orientations of these fractures. The systems integrate the sonic log data and the image log data to identify low fracture density areas and high fracture density areas as well as various geomechanical properties of the subsurface region of the survey area.

In some examples, a temperature measurement module measures temperature profiles and collects temperature measurements from the DTS fiber system in the vertical observation well and the wireline temperature sensors in the horizontal wells. The DTS fiber system uses optical fibers as linear sensors to measure temperature profiles continuously along the length of the fiber. The DTS fiber system sends laser pulses through the fiber and analyzes the backscattered light to measure the temperature profiles. The wireline temperature sensors use thermistors or platinum elements to detect temperature changes in a well. The temperature measurements from the DTS fiber system and the wireline temperature sensors are recorded against depth and location, facilitating a 3D temperature mapping of the survey area.

In some examples, an XRD analysis module analyzes well cuttings to identify and model volcanic packages. The XRD analysis module compares diffraction patterns of the well cuttings with known mineral patterns to determine the presence of the volcanic packages. In some examples, a model update module is configured to iteratively update the 3D geologic model using new data from each newly drilled well. With the newly drilled wells, the model update module measures drilling induced fractures to determine, for example, a stress field orientation across the survey site. Using new image log data and new sonic data captured from the newly drilled wells, geologic characteristics (e.g., SHmax) are calculated and updated.

The present invention has application to oil and gas activities, such as waterflooding, steam flooding, steam assisted gravity drainage, and enhanced oil recovery. The present application has application to geothermal energy activities, where thermal energy is extracted from subsurface formations by circulating a working fluid, such as water or carbon dioxide, through the formation and recovering the heated fluid. It should be understood that while the examples described herein involve the recovery of geothermal resources and hydrocarbon resources from beneath the surface of the earth, the present invention is not so limited. Thus, the present invention described herein, including the geologic modeling, may find applicability in the recovery of minerals and ores, and other resources within the ground.

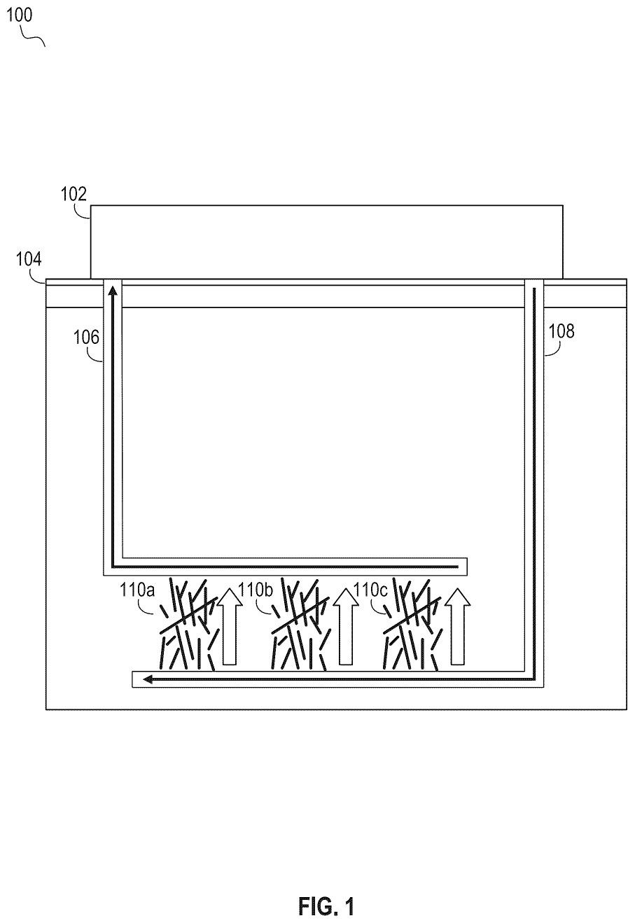

FIG. 1 illustrates an example 100 of a natural resource system 102, in accordance with examples described herein. For example, the natural resource system 102 may pump fluid or gas from one or more geothermal energy sources. Typically, in the production of natural resources from formations within the earth a well or borehole is drilled into the earth to the location where the natural resource is believed to be located. These natural resources may be a heat source for geothermal energy, a hydrocarbon reservoir, containing natural gas, crude oil and combinations of these; the natural resource may be fresh water; or it may be some other natural resource that is located within the ground.

Generally, when a well is drilled into these formations the natural resources rarely flow into and out of the formation, and into the well at rates, durations and amounts that are economically viable. This problem can relate to the viscosity of the natural resource, the porosity of the formation, the geology of the formation, the formation pressures, and the perforations that place the production tubing in the well in fluid communication with the formation, to name a few.

In drilling a well, an initial borehole is made into the earth, and then, subsequent and smaller diameter boreholes are drilled to extend the overall depth of the borehole. In this manner, as the overall borehole gets deeper its diameter becomes smaller; resulting in what can be envisioned as a telescoping assembly of holes with the largest diameter hole being at the top of the borehole closest to the surface of the earth.

Typically, when completing a well, it is necessary to perform a perforation operation. In general, when a well has been drilled and casing (e.g., a metal pipe) is run to the prescribed depth, the casing is typically cemented in place by pumping cement down and into the annular space between the casing and the earth. The casing, among other things, prevents the hole from collapsing and fluids from flowing between permeable zones in the annulus. Thus, this casing forms a structural support for the well and a barrier to the earth.

Boreholes are generally formed and advanced by using mechanical drilling equipment having a rotating drilling tool (e.g., a bit). For example, when creating a borehole in the earth, a drilling bit is extending to and into the earth and rotated to create a hole in the earth. In general, to perform the drilling operation the bit must be forced against the material to be removed with a sufficient force to exceed the shear strength, compressive strength, or combinations thereof, of that material.

As illustrated in FIG. 1, the natural resource system 102 can inject a fluid or a gas through a subsurface 104 via an injection well 108 to fractures 110a, 110b, 110c. The fractures 110a, 110b, 110c can be part of an enhanced geothermal system, which can be a man-made reservoir created where there is hot rock but insufficient or little natural permeability or fluid saturation. In some instances, fluid or gas can be injected through the injection well 108 to cause the fractures 110a, 110b, 110c to open or re-open to creating permeability. In some instances, fluid or gas can be injected through the injection well 108 as part of a flow through the fractures 110a, 110b, 110c. The flow through the fractures 110a, 110b, 110c can be enhanced through reservoir stimulation. Here, stimulation of multiple fractures, such as the fractures 110a, 110b, 110c, allows for an area to be stimulated in a series of smaller stimulations, minimizing local stress perturbations. The stimulation of multiple fractures provides for access to significantly more of the reservoir and provides additional flow opportunities, increasing overall flow rate. For example, through multizone stimulation flow rates of 40-80 kg/s for commercial production may be achieved where stimulation of a single fracture may fail to achieve a flow greater than 25 kg/s.

As illustrated in FIG. 1, fluid or gas can flow from the fractures 110a, 110b, 110c to the natural resource system 102 through the subsurface 104 via a production well 106. The natural resource system 102 can extract energy (e.g., heat, thermal energy) from the fluid or the gas from the fractures 110a, 110b, 110c. As illustrated in FIG. 1, the injection well 108 and the production well 106 can be horizontal wells. The injection well 108 and the production well 106 can have limited entry completion designs to maximize thermal sustainability. In general, limited entry completion designs refer to well stimulation techniques that effectively treat multiple zones simultaneously. Through limited entry completion designs, even stimulation and uniform flow can be achieved.

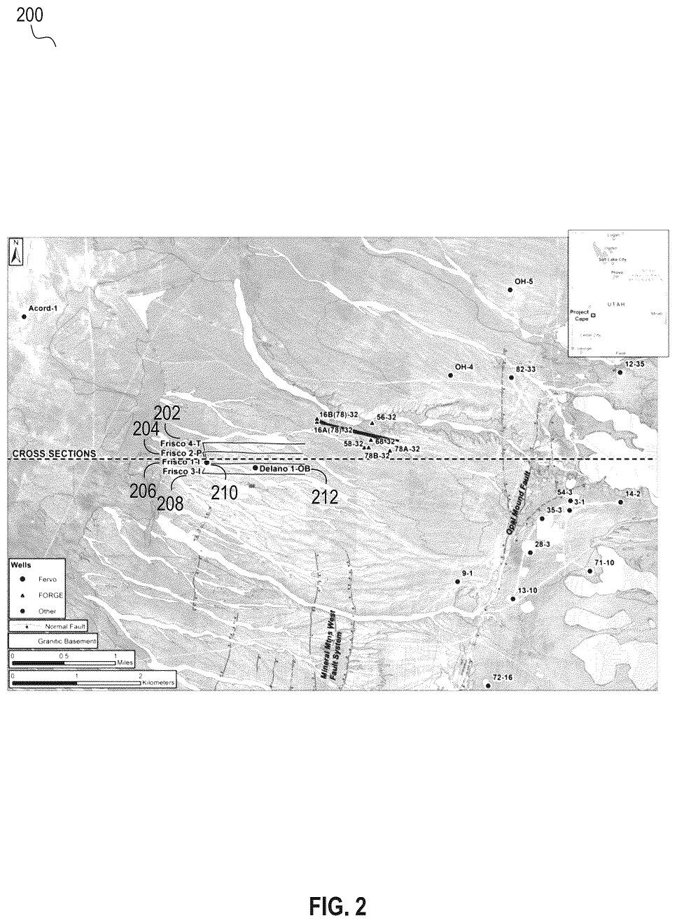

FIG. 2 illustrates an example 200 of a geothermal well system, in accordance with examples described herein. The example 200 includes horizontal wells 202, 204, 206, 208 drilled from a vertical well 210. The example 200 includes a vertical observation well 212. In the example 200, the horizontal wells 202, 204, 206, 208 are drilled in a wine rack pattern with lateral sections positioned at vertical depths between 8,000 ft and 9,000 ft.

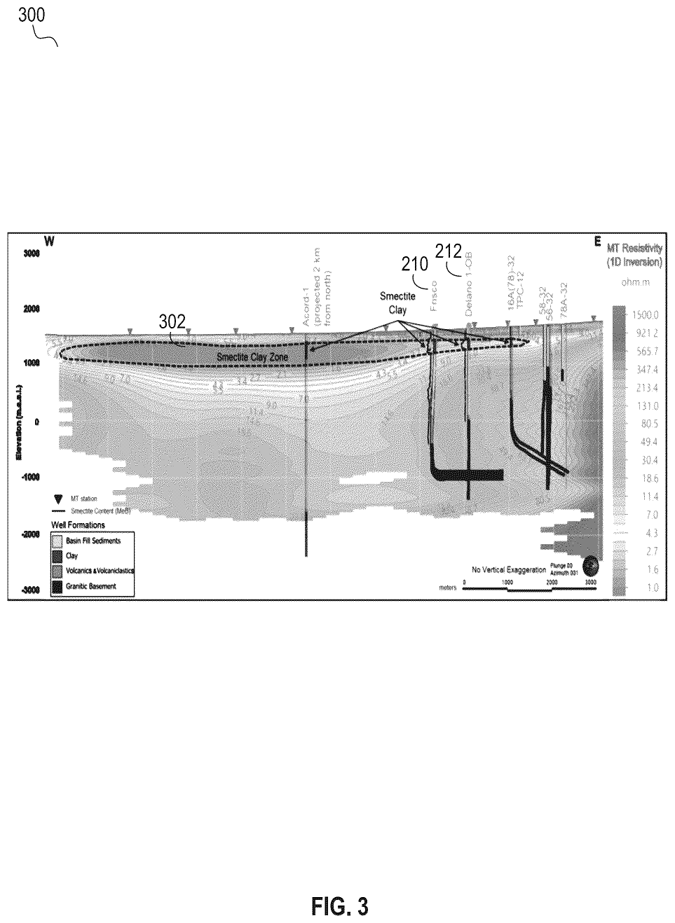

FIG. 3 illustrates an example 300 of magnetotelluric (MT) data of a geothermal well system, in accordance with examples described herein. The example 300 illustrates MT resistivity against depth in the geothermal well system. The example 300 illustrates the vertical well 210 and the vertical observation well 212 drilled to depths between 8,000 ft and 9,000 ft. The vertical well 210 and the vertical observation well 212 intersect a smectite clay zone 302. The smectite clay zone 302 is identified by correlating the MT data of the geothermal well system with well logs. The smectite clay zone 302 is identified through the MT data as having MT resistivity between about 1.0 ohm.m and about 10.0 ohm.m.

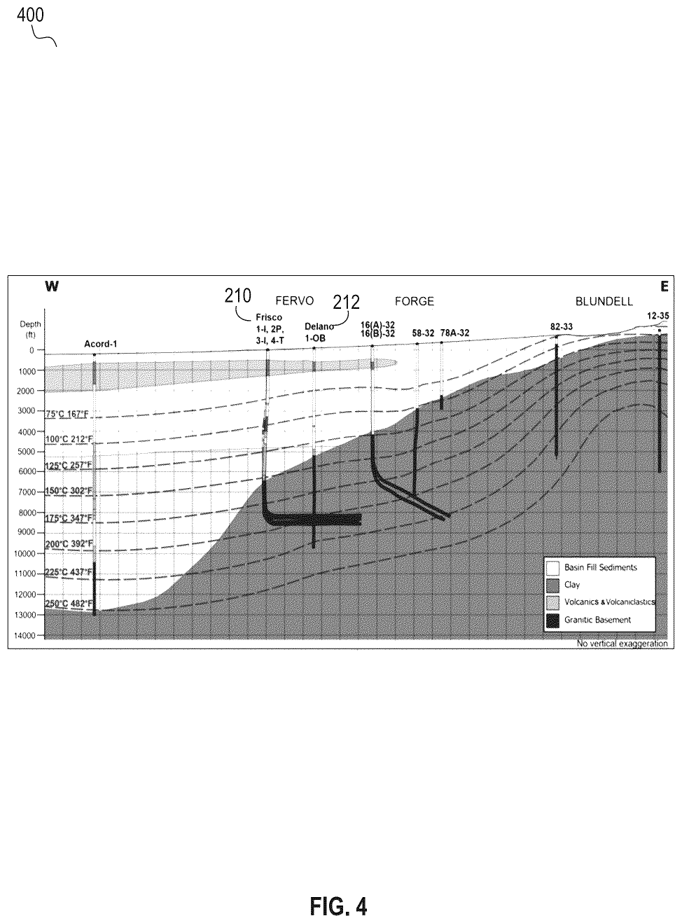

FIG. 4 illustrates an example 400 of geologic data and temperature data of a geothermal well system, in accordance with examples described herein. The example 400 illustrates geological formations in the geothermal well system, including basin fill sediments, clay, volcanics and volcaniclastics, and granitic basement. The example 400 illustrates the temperature data corresponding with the geological formations with temperature ranges between 75° C. and 250° C. The geologic data and the temperature data of the example 400 shows the vertical well 210 and the vertical observation well 212 intersecting basin fill sediments, clay, volcanics, to the granitic basement at depths between 8,000 ft and 9,000 ft and temperatures between 175° C. and 235° C.

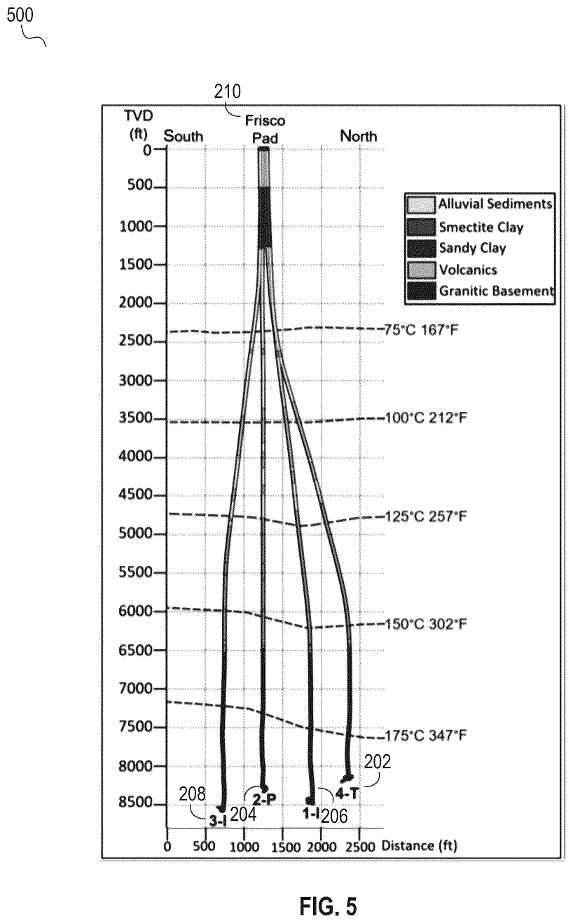

FIG. 5 illustrates an example 500 of geologic data and temperature data of a geothermal well system, in accordance with examples described herein. The example 500 illustrates the vertical well 210 and the horizontal wells 202, 204, 206, 208 intersecting alluvial sediments, smectite clay, sandy clay, and volcanics to the granitic basement. The horizontal wells 202, 204, 206, 208 are spaced about 500 ft to about 1000 ft apart at a depth of about 8,500 ft. At this depth, the temperature of the horizontal wells 202, 204, 206, 208 is about 200° C.

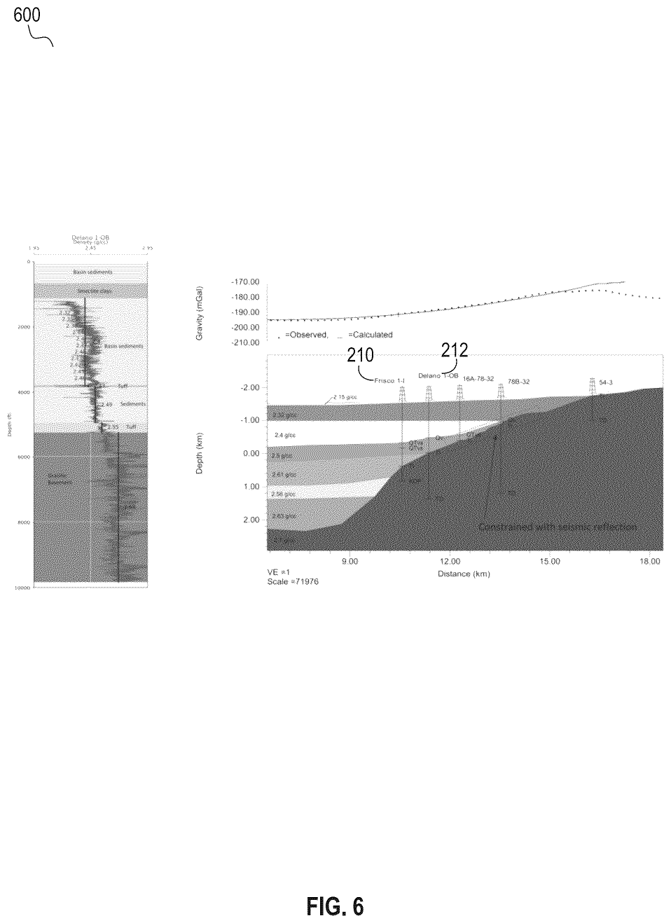

FIG. 6 illustrates an example 600 of gravity data of a geothermal well system, in accordance with examples described herein. The example 600 illustrates gravity observed and calculated over the geothermal well system and the corresponding densities for the geothermal well system. As illustrated in the example 700, the vertical well 210 and the vertical observation well 212 intersect densities corresponding with the granitic basement at about 6,500 ft.

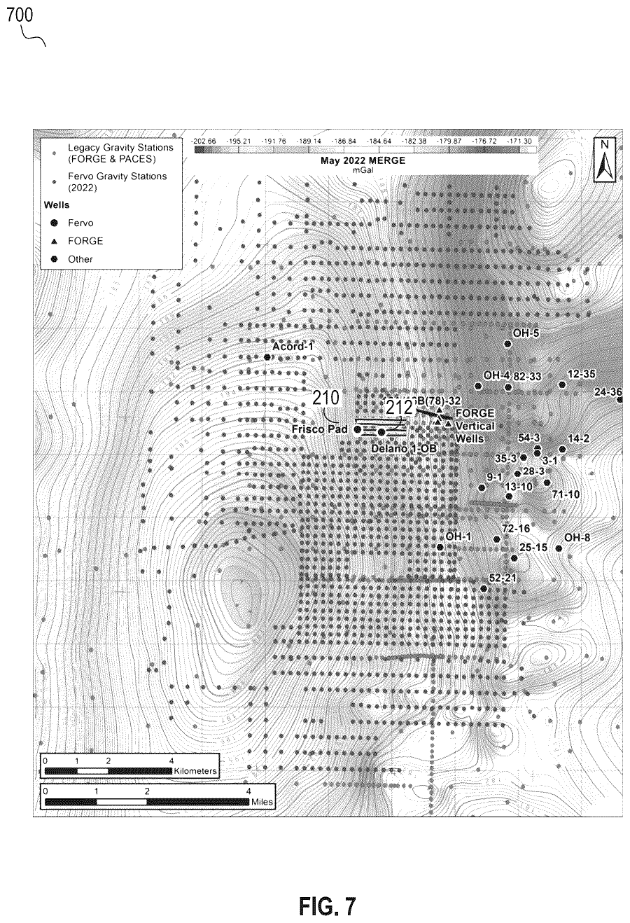

FIG. 7 illustrates an example 700 of gravity data of a geothermal well system, in accordance with examples described herein. The example 700 shows a map of the geothermal well system where gravity measurements were obtained around the vertical well 210 and the vertical observation well 212. As illustrated in the example 700, the gravity measurements were obtained from gravity stations spaced about 250 m apart near the core survey area around the vertical well 210 and the vertical observation well 212 and spaced about 1 km apart away from the core survey area.

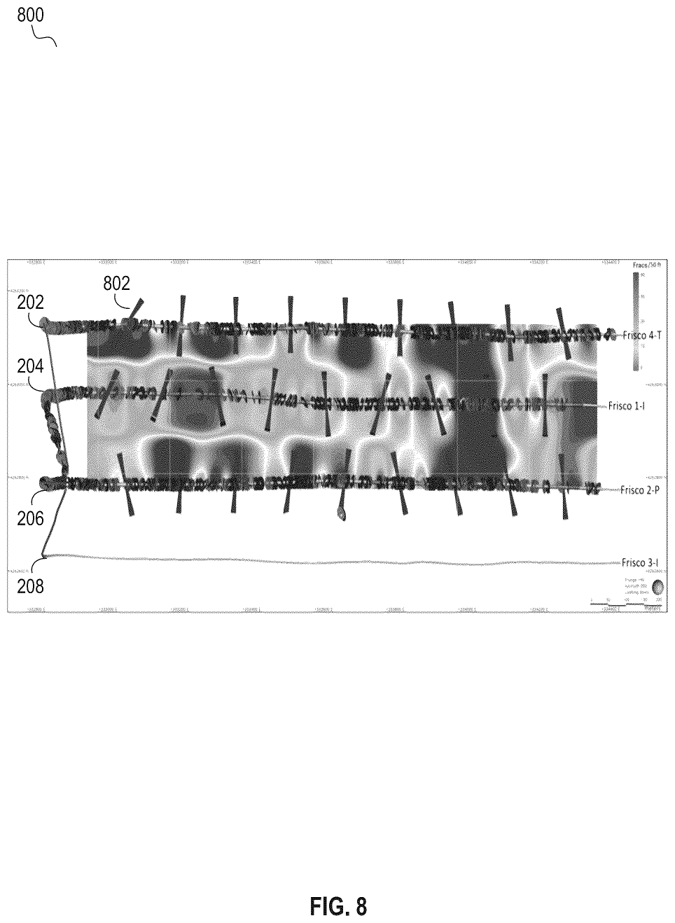

FIG. 8 illustrates an example 800 of density data of a geothermal well system, in accordance with examples described herein. The example 800 illustrates varying fracture densities around the horizontal wells 202, 204, 206, 208 with darker areas representing higher density zones and lighter areas representing lower density zones. The example 800 illustrates average natural fracture orientations 802 measured every 500 ft along each of the horizontal wells 202, 204, 206, 208.

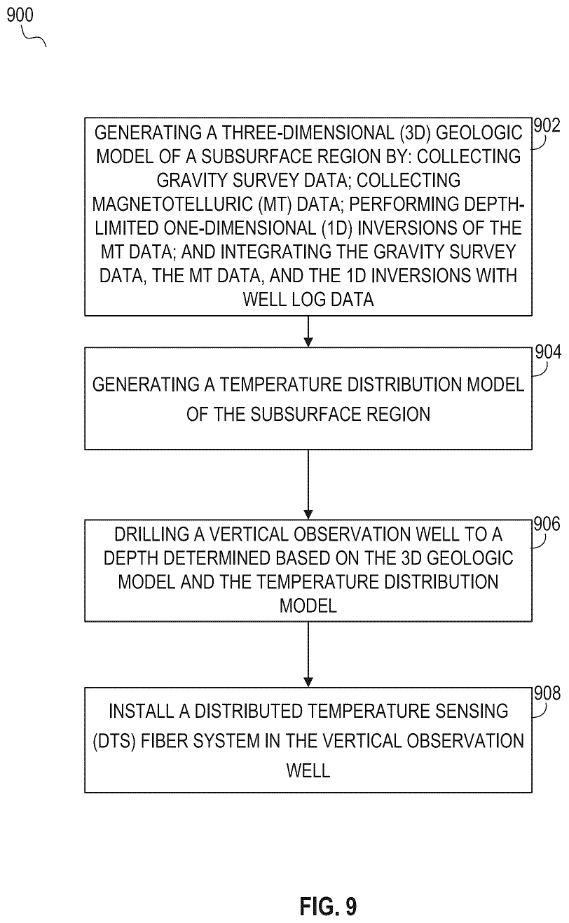

FIG. 9 illustrates an example technique 900 for developing and characterizing a geothermal well system, in accordance with examples described herein. The operations of the example technique 900 are illustrative, and the sequence may be altered without departing from the scope of the present invention. For example, the example technique 900 can be performed with additional or fewer operations. The operations of the example technique 900 can be performed in sequence, in parallel, or in different orders. In some examples, different components of an example device or system that implements an example technique may perform operations at substantially the same time or in a specific sequence.

At 902, the example technique 900 generates a three-dimensional (3D) geologic model of a subsurface region by: collecting gravity survey data; collecting magnetotelluric (MT) data; performing depth-limited one-dimensional (1D) inversions of the MT data; and integrating the gravity survey data, the MT data, and the 1D inversions with well log data. The 3D geologic model may be generated, for example, in accordance with the details provided in FIGS. 2-8.

At 904, the example technique 900 generates a temperature distribution model of the subsurface region. The temperature distribution model may be generated, for example, in accordance with the details provided in FIGS. 4-5.

At 906, the example technique 900 drills a vertical observation well to a depth determined based on the 3D geologic model and the temperature distribution model. The vertical observation well may be drilled, for example, in accordance with the details provided in FIGS. 2-8.

At 908, the example technique 900 installs a distributed temperature sensing (DTS) fiber system in the vertical observation well. The DTS fiber system may be installed, for example, in accordance with the details provided in FIGS. 4-5.

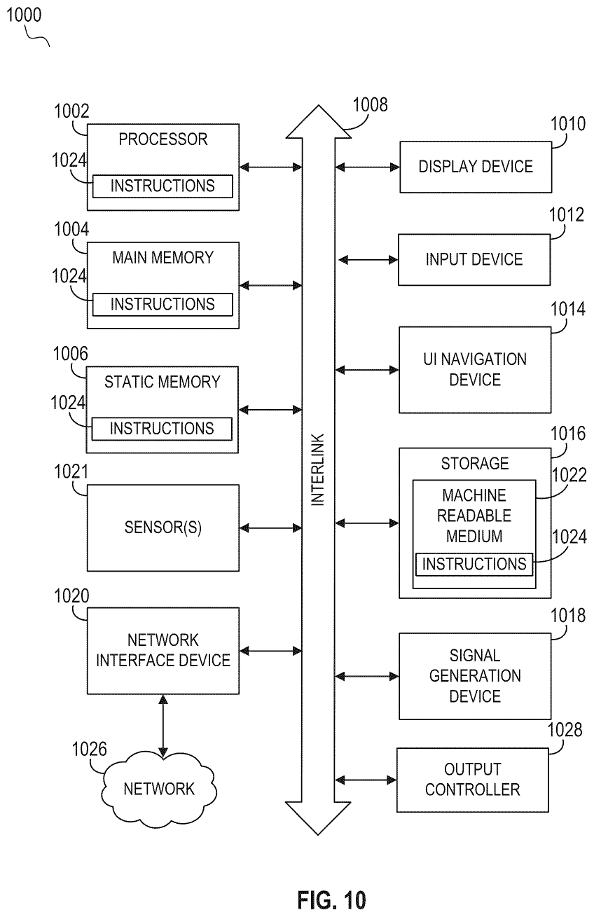

FIG. 10 illustrates generally an example of a block diagram of a machine 1000 upon which any one or more of the techniques (e.g., methodologies) discussed herein may perform in accordance with some examples. In alternative examples, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a display unit 1010, an alphanumeric input device 1012 (e.g., a keyboard), and a user interface (UI) navigation device 1014 (e.g., a mouse). In an example, the display unit 1010, alphanumeric input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine readable medium 1022 that is non-transitory on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

While the machine readable medium 1022 is illustrated as a single medium, the term “machine readable medium” may include a single medium or multiple media (e.g., a centralized or distributed database, or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software.

### Glossary

Generally, the term “about” and the symbol “˜” as used herein unless stated otherwise is meant to encompass a variance or range of +10%, the experimental or instrument error associated with obtaining the stated value, and preferably the larger of these.

As used herein, unless specified otherwise, the terms “formation”, “reservoir”, “pay zone”, and similar terms are to be given their broadest possible meanings, and include all locations, areas, and geological features within the earth that contain, may contain, or are believed to contain, a desired resource (e.g., geothermal heat, hydrocarbons, etc.).

As used herein, unless specified otherwise, the terms “field”, “oil field”, “geothermal field”, and similar terms are to be given their broadest possible meanings, and include any area of land, sea floor, or water that is loosely or directly associated with a formation, and more particularly, with a resource containing formation. Thus, a field may have one or more exploratory and producing wells associated with it. A field may have one or more governmental body or private resource leases associated with it. A field may be directly associated with a resource containing formation.

As used herein, unless specified otherwise, the terms “geothermal”, “geothermal well”, “geothermal resource”, “geothermal energy”, and similar terms are to be given their broadest possible meanings, and include systems and operations, including wells, that recover or utilize the heat energy that is contained within the earth. Such systems and operations include enhanced geothermal well, engineered geothermal wells, binary cycle power plants, dry steam power plants, flash steam power plants, open looped systems, and closed loop systems.

As used herein, unless specified otherwise, the term “earth” should be given its broadest possible meaning, and includes, the ground, all natural materials, such as rocks, and artificial materials, such as concrete, that are or may be found in the ground, including without limitation rock layer formations, such as, granite, basalt, sandstone, dolomite, sand, salt, limestone, rhyolite, quartzite and shale rock.

As used herein, unless specified otherwise, the term “borehole” should be given it broadest possible meaning and includes any opening that is created in a material, a work piece, a surface, the earth, a structure (e.g., building, protected military installation, nuclear plant, offshore platform, or ship), or in a structure in the ground, (e.g., foundation, roadway, airstrip, cave or subterranean structure) that is substantially longer than it is wide, such as a well, a well bore, a well hole, a micro hole, a slimhole, a perforation, or other term commonly used to define these types of long narrow passages. Wells would further include exploratory, production, abandoned, reentered, reworked, and injection wells. Although boreholes are generally oriented substantially vertically, they may also be oriented on an angle from vertical, to and including horizontal. Thus, using a vertical line, based upon a level as a reference point, a borehole can have orientations ranging from 0° i.e., vertical, to 90°, i.e., horizontal and greater than 90° e.g., such as a heel and toe and combinations of these such as for example “U” and “Y” shapes. Boreholes may further have segments or sections that have different orientations, they may have straight sections and arcuate sections and combinations thereof; and for example, may be of the shapes commonly found when directional drilling is employed. Thus, as used herein unless expressly provided otherwise, the “bottom” of a borehole, the “bottom surface” of the borehole and similar terms refer to the end of the borehole, i.e., that portion of the borehole furthest along the path of the borehole from the borehole's opening, the surface of the earth, or the borehole's beginning. The terms “side” and “wall” of a borehole should to be given their broadest possible meaning and include the longitudinal surfaces of the borehole, whether or not casing or a liner is present, as such, these terms would include the sides of an open borehole or the sides of the casing that has been positioned within a borehole. Boreholes may be made up of a single passage, multiple passages, connected passages and combinations thereof, in a situation where multiple boreholes are connected or interconnected each borehole would have a borehole bottom. Boreholes may be formed in the sea floor, under bodies of water, on land, in ice formations, or in other locations and settings.

As used herein, phrases of the form “at least one of an A, a B, or a C”, “at least one of A, B, or C”, “at least one of A, B, and C”, and similar phrases, should be interpreted to select at least one from the group that comprises A, B, and C. Unless explicitly stated otherwise in connection with a particular instance, this manner of phrasing does not mean “at least one of A, at least one of B, and at least one of C.” As used herein, the example “at least one of an A, a B, or a C” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method for developing and characterizing a geothermal well system, comprising: generating a three-dimensional (3D) geologic model of a subsurface region, the generating comprising: collecting gravity survey data; collecting magnetotelluric (MT) data; performing depth-limited one-dimensional (1D) inversions of the MT data; and integrating the gravity survey data, the MT data, and the 1D inversions with well log data; generating a temperature distribution model of the subsurface region; drilling a vertical observation well to a depth determined based on the 3D geologic model and the temperature distribution model; and installing a distributed temperature sensing (DTS) fiber system in the vertical observation well.

In Example 2, the subject matter of Example 1 comprises characterizing natural fractures in the subsurface region, the characterizing comprising: collecting image log data from horizontal wells of the subsurface region; calculating fracture densities along the horizontal wells; measuring average fracture strike orientations along the horizontal wells; and integrating sonic log data with the image log data.

In Example 3, the subject matter of Example 2 comprises wherein the fracture densities are calculated at 50 foot intervals along the horizontal wells, and wherein the average fracture strike orientations are measured at 500 foot intervals along the horizontal wells.

In Example 4, the subject matter of Examples 1-3 comprises measuring temperature profiles of the subsurface region, the measuring comprising: collecting first temperature data from the DTS fiber system in the vertical observation well; and collecting second temperature data from wireline temperature sensors in horizontal wells of the subsurface region.

In Example 5, the subject matter of Examples 1-4 comprises mapping a clay zone in the subsurface region based on correlations between the 1D inversions and the well log data.

In Example 6, the subject matter of Examples 1-5 comprises collecting x-ray diffraction (XRD) data of well cuttings in horizontal wells of the subsurface region; and modeling volcanic packages in the subsurface region for the 3D geologic model.

In Example 7, the subject matter of Examples 1-6 comprises measuring fracture orientations of induced fractures along the vertical observation well and horizontal wells of the subsurface region; and determining a stress field orientation based on the fracture orientations.

In Example 8, the subject matter of Examples 1-7 comprises iteratively updating the 3D geologic model based on data obtained from newly drilled wells.

In Example 9, the subject matter of Examples 1-8 comprises wherein the temperature distribution model is generated using a radial basis function algorithm.

In Example 10, the subject matter of Examples 1-9 comprises wherein the subsurface region comprises horizontal wells in a wine rack pattern.

Example 11 is a system for developing and characterizing a geothermal well system, the system comprising: one or more processors; and memory storing instructions that, when executed by the one or more processors, cause the system to perform operations comprising: generating a three-dimensional (3D) geologic model of a subsurface region, the generating comprising: collecting gravity survey data; collecting magnetotelluric (MT) data; performing depth-limited one-dimensional (1D) inversions of the MT data; and integrating the gravity survey data, the MT data, and the 1D inversions with well log data; generating a temperature distribution model of the subsurface region; drilling a vertical observation well to a depth determined based on the 3D geologic model and the temperature distribution model; and installing a distributed temperature sensing (DTS) fiber system in the vertical observation well.

In Example 12, the subject matter of Example 11 comprises characterizing natural fractures in the subsurface region, the characterizing comprising: collecting image log data from horizontal wells of the subsurface region; calculating fracture densities along the horizontal wells; measuring average fracture strike orientations along the horizontal wells; and integrating sonic log data with the image log data.

In Example 13, the subject matter of Examples 11-12 comprises measuring temperature profiles of the subsurface region, the measuring comprising: collecting first temperature data from the DTS fiber system in the vertical observation well; and collecting second temperature data from wireline temperature sensors in horizontal wells of the subsurface region.

In Example 14, the subject matter of Examples 11-13 comprises mapping a clay zone in the subsurface region based on correlations between the 1D inversions and the well log data.

Example 15 is one or more non-transitory computer-readable media storing computer-executable instructions that, when executed by a computing system, cause the computing system to perform operations comprising: generating a three-dimensional (3D) geologic model of a subsurface region, the generating comprising: collecting gravity survey data; collecting magnetotelluric (MT) data; performing depth-limited one-dimensional (1D) inversions of the MT data; and integrating the gravity survey data, the MT data, and the 1D inversions with well log data; generating a temperature distribution model of the subsurface region; drilling a vertical observation well to a depth determined based on the 3D geologic model and the temperature distribution model; and installing a distributed temperature sensing (DTS) fiber system in the vertical observation well.

The present invention may be embodied in other forms than those specifically disclosed herein without departing from the spirit or essential characteristics of the present invention. The described examples are to be considered in all respects only as illustrative and not restrictive.

The various examples of systems, compositions, articles, uses, applications, equipment, methods, activities, and operations set forth in this specification may be used for various other fields and for various other activities, uses and examples. Additionally, these examples may be used with: existing systems, compositions, articles, uses, applications, equipment, methods, activities, and operations; may be used with systems, compositions, articles, uses, applications, equipment, methods, activities, and operations that may be developed in the future; and with such systems, compositions, articles, uses, applications, equipment, methods, activities, and operations that may be modified, in-part, based on the teachings of this specification. Further, the various examples set forth in this specification may be used with each other, in whole or in part, and in different and various combinations. Thus, for example, the configurations provided in the various examples of this specification may be used with each other; and the scope of protection afforded the present inventions should not be limited to a particular example, configuration or arrangement that is set forth in a particular example, or in an example in a particular figure.

What is claimed is:

1. A method for developing and characterizing a geothermal well system, comprising:
generating a three-dimensional (3D) geologic model of a subsurface region, the generating comprising:
collecting gravity survey data;
collecting magnetotelluric (MT) data;
performing depth-limited one-dimensional (1D) inversions of the MT data; and
integrating the gravity survey data, the MT data, and the 1D inversions with well log data;
generating a temperature distribution model of the subsurface region;
drilling a vertical observation well to a depth determined based on the 3D geologic model and the temperature distribution model; and
installing a distributed temperature sensing (DTS) fiber system in the vertical observation well.

2. The method of claim 1, further comprising:
characterizing natural fractures in the subsurface region, the characterizing comprising:
collecting image log data from horizontal wells of the subsurface region;
calculating fracture densities along the horizontal wells;
measuring average fracture strike orientations along the horizontal wells; and
integrating sonic log data with the image log data.

3. The method of claim 2, wherein the fracture densities are calculated at 50 foot intervals along the horizontal wells, and wherein the average fracture strike orientations are measured at 500 foot intervals along the horizontal wells.

4. The method of claim 1, further comprising:
measuring temperature profiles of the subsurface region, the measuring comprising:
collecting first temperature data from the DTS fiber system in the vertical observation well; and
collecting second temperature data from wireline temperature sensors in horizontal wells of the subsurface region.

5. The method of claim 1, further comprising:
mapping a clay zone in the subsurface region based on correlations between the 1D inversions and the well log data.

6. The method of claim 1, further comprising:
collecting x-ray diffraction (XRD) data of well cuttings in horizontal wells of the subsurface region; and
modeling volcanic packages in the subsurface region for the 3D geologic model.

7. The method of claim 1, further comprising:
measuring fracture orientations of induced fractures along the vertical observation well and horizontal wells of the subsurface region; and
determining a stress field orientation based on the fracture orientations.

8. The method of claim 1, further comprising:
iteratively updating the 3D geologic model based on data obtained from newly drilled wells.

9. The method of claim 1, wherein the temperature distribution model is generated using a radial basis function algorithm.

10. The method of claim 1, wherein the subsurface region comprises horizontal wells in a wine rack pattern.

11. A system for developing and characterizing a geothermal well system, the system comprising:
one or more processors; and
memory storing instructions that, when executed by the one or more processors, cause the system to perform operations comprising:
generating a three-dimensional (3D) geologic model of a subsurface region, the generating comprising:
collecting gravity survey data;
collecting magnetotelluric (MT) data;
performing depth-limited one-dimensional (1D) inversions of the MT data; and
integrating the gravity survey data, the MT data, and the 1D inversions with well log data;
generating a temperature distribution model of the subsurface region;
drilling a vertical observation well to a depth determined based on the 3D geologic model and the temperature distribution model; and
installing a distributed temperature sensing (DTS) fiber system in the vertical observation well.

12. The system of claim 11, the operations further comprising:
characterizing natural fractures in the subsurface region, the characterizing comprising:
collecting image log data from horizontal wells of the subsurface region;
calculating fracture densities along the horizontal wells;
measuring average fracture strike orientations along the horizontal wells; and
integrating sonic log data with the image log data.

13. The system of claim 11, the operations further comprising:
measuring temperature profiles of the subsurface region, the measuring comprising:
collecting first temperature data from the DTS fiber system in the vertical observation well; and
collecting second temperature data from wireline temperature sensors in horizontal wells of the subsurface region.

14. The system of claim 11, the operations further comprising:
mapping a clay zone in the subsurface region based on correlations between the 1D inversions and the well log data.

15. One or more non-transitory computer-readable media storing computer-executable instructions that, when executed by a computing system, cause the computing system to perform operations comprising:
generating a three-dimensional (3D) geologic model of a subsurface region, the generating comprising:
collecting gravity survey data;
collecting magnetotelluric (MT) data;
performing depth-limited one-dimensional (1D) inversions of the MT data; and
integrating the gravity survey data, the MT data, and the 1D inversions with well log data;
generating a temperature distribution model of the subsurface region;
drilling a vertical observation well to a depth determined based on the 3D geologic model and the temperature distribution model; and
installing a distributed temperature sensing (DTS) fiber system in the vertical observation well.
